(19) United States
(12) Patent Application Publication
(10) Pub. No.: US 2003/0115173 A1
(43) Pub. Date: Jun. 19, 2003

(54) Intelligent document management and usage method

(76) Inventor: Tsung-Yuan Liu, Kaohsiung (TW)

Correspondence Address: J.C. Patents, Inc., Suite 250, 4 Venture, Irvine, CA, 92618, US

(21) Appl. No.: 10/090,114

(22) Filed: Feb. 27, 2002

(30) Foreign Application Priority Data
Dec. 17, 2001 (TW) 90131189

(51) Int. Cl. G06F 7/00

(52) U.S. Cl. 707/1

(57) ABSTRACT

An intelligent document management and usage method, comprising the steps of: extracting at least one keyword from each document respectively, and using it as the attribute row corresponding to the document; then, providing a keyword directory table to the display screen for user usage and management, wherein the keyword directory table comprises a plurality of first keyword directories that are composed of the union of the keywords contained in the document. When the user selects one of the first keyword directories, the document link points contained in the first keyword directory are displayed. Moreover, a parent-son hierarchical relationship of the first keyword directory and a plurality of second keyword directories contained in the first keyword directory is also displayed. The second keyword directories are united by the keywords of all documents contained in the first keyword directory corresponding to the upper layer except for the keyword of the upper layer. When the user repeatedly processes the operation of selecting the lower layer keyword directories, as long as the keyword directory of some specific layer displays the document link point of the document needed by user, the user can select the needed document.

### CROSS-REFERENCE TO RELATED APPLICATION

This application claims the priority benefit of Taiwan application serial no. 90131189, filed Dec. 17, 2001.

### BACKGROUND OF THE INVENTION

1. Field of Invention

The present invention generally relates to an intelligent document management and usage method, and more particularly, to an intelligent document management and usage method for Intranet and personal computer.

2. Description of Related Art

Intranet is the abbreviation of the Intra-business Internet, building the computer network within an enterprise by using the Internet concept, so each employee of the company can have his/her own HomePage and E-mail mailbox. Moreover, document transfer within the company can be achieved with certainty via each employee's e-mail address, so it is not necessary to remember each employee's disk directory.

After the Intranet is built, not only can an employee easily utilize the Internet to communicate with company's server for information transfer, but also a user who is not an employee of the company can easily get to the network to browse the introductory homepage via the Internet.

If the Microsoft Windows system is used as the internal operating system of the company, in addition to e-mail commonly used to transfer the information, a network having the function of sharing files can also be used directly to get data from the server or from another colleague's personal computer. Thus, time spent sending e-mail can be eliminated, and the problem of files being too big to save on a 1.44 MB floppy diskette can be solved.

However, sometimes it is not known which directory or which file the data is in when searching for the file information. For example, if we want to search in the database for a case A related to the Circuit cases of a patent of the year 2000, the case must be classified in the very beginning when the file is created, which means it is required to create a year 2000 directory, and create a patent directory inside the year 2000 directory, and also create a circuit cases directory inside the patent directory. This is not easy, especially when a file is really difficult to classify to some specific category. Therefore, file management is getting more and more difficult day by day. Everyone has encountered this kind of situation, especially when file information spans across multiple fields. A possible method is just to assign this file into one of the categories first, and then search for it later, but over time the searching time is increased. Another option is to save the same copy of the file in every related classified directory. However, in such a case the data size of the database is increased greatly.

### SUMMARY OF THE INVENTION

In view of this, the present invention provides an intelligent document management and usage method, to dynamically generate the search path related to file data when the file data is added, and the file data can also be found via different search paths. When the file data is added, the related directory is automatically generated or the file is added into the related directory automatically if the directory exists. Moreover, the directory shown on the screen is a hierarchical directory, and the directories that have been selected by the user are all displayed on the screen.

No matter whether a company or a personal computer, storage media exists therein. The storage media stores a plurality of documents, and there is a document link point corresponding to each document in the present invention.

The intelligent document management and usage method, comprises the steps of: extracting at least one keyword from each document respectively, and using it as the attribute row corresponding to the document, that is, the attribute row comprises one or more than one keywords that are used as the search path for searching the document; afterwards, providing a keyword directory table on the display screen for user usage and management, the keyword directory table comprising a plurality of keyword directories that are located in the first layer, these first layer keyword directories are composed of the union of the keywords contained in all documents stored automatically.

When the user selects one of the first layer keyword directories, the document link points contained in the first layer keyword directory are displayed. Moreover, a parent-son hierarchical relationship of the first layer keyword directory and a plurality of second layer keyword directories contained in the first layer keyword directory is also displayed. The second layer keyword directories are united by the keywords of all documents contained in the first layer keyword directory corresponding to the upper layer except for the keyword of the upper layer.

When the user repeatedly processes the operation of selecting the lower layer keyword directories, as long as the keyword directory of some specific layer displays the document link point of the document needed by the user, the user can select the needed document.

The physical method to obtain the first layer keyword directory and the second layer keyword directory mentioned above is: at the very beginning, providing a document list that is related to all the documents stored in the storage media; obtaining a keyword list by using the extracted keywords; obtaining a relationship index table of the documents and the keywords according to the document list and the keyword list.

The first layer keyword directory and the second layer keyword directory are generated according to the union by the keywords of the selected documents in the relationship index table.

In summary, the present invention utilizes the method of using the attribute row of the document, and excluding the keyword of the upper layer to dynamically generate the lower layer keyword directory. Moreover, the search path is obtained from the keyword that is contained in the attribute row of each document, so even if the path or the sequence of the keywords selected by the user is different, the document can be found as long as the selected keyword belongs to the keywords that are contained in the document.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 schematically shows a flow chart of the intelligent document management and usage method of a preferred embodiment according to the present invention;

FIG. 2 schematically shows the present invention according to FIG. 1; and

FIG. 3 schematically shows the intelligent document management and usage method of another preferred embodiment according to the present invention.

### DESCRIPTION OF THE PREFERRED EMBODIMENTS

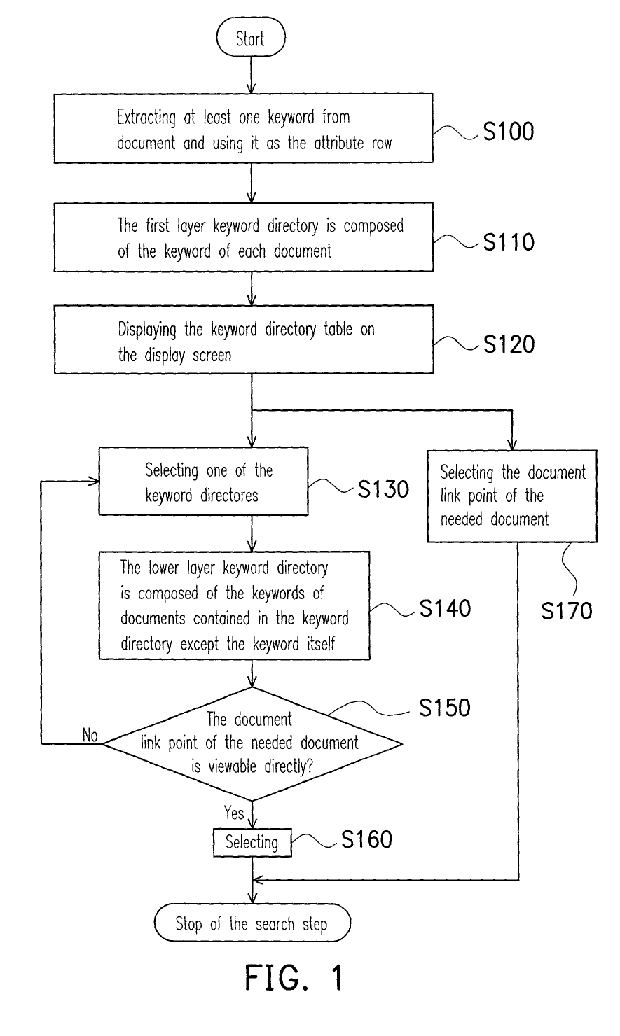

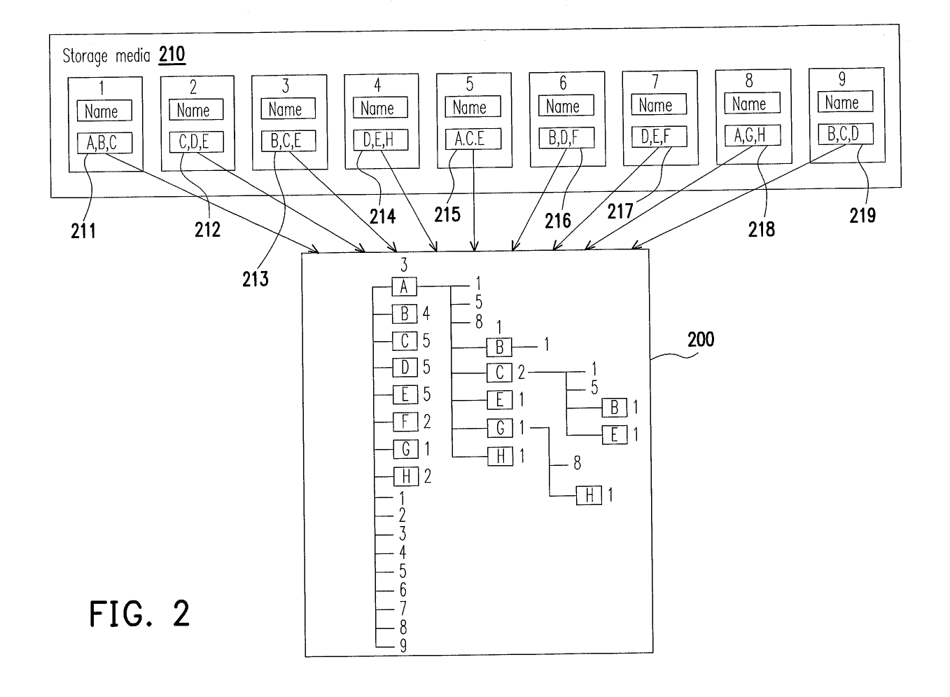

Referring to both FIG. 1 and FIG. 2, an intelligent document management and usage method of a preferred embodiment according to the present invention is schematically shown. The storage media 210 is used to store a plurality of documents, and there is a document link point corresponding to each of these documents. In the present embodiment, if the storage media 210 is applied in the Intra-business Internet, i.e. Intranet, the storage media 210 is a database. Moreover, in the present embodiment, it is assumed that there are 9 documents that have been created in the storage media 210, and the user is searching for the needed data from these 9 documents.

Searching comprises the steps of: automatically extracting at least one keyword from each document respectively, and using it as the attribute row that corresponds to each document (step s100), for example extracting the keyword of each document from the contents of 9 documents as listed in FIG. 2 respectively to form the attribute row 211˜219. Each attribute row has 3 keywords, for the simplified description in the present embodiment, but it is not always necessary to extract 3 keywords from each document for the attribute row.

When the user starts the search, a keyword directory table 200 is displayed on the display screen or the desktop for the user to search (step s120). The keyword directory table 200 displayed on the display screen comprises the document link points of all documents and a plurality of first layer keyword directories. The document link points are document link points 1, 2, 3, 4, 5, 6, 7, 8, 9 respectively, and the first layer keyword directory is {A, B, C, D, E, F, G, H} respectively. The first layer keyword directories are composed of the union by the keywords contained in the documents stored in the storage media 210 mentioned above (step s110).

It is assumed the user is searching for the document related to the keyword A and B. Thus, the user can search for the needed document from keyword A or from keyword B, and when the user selects the directory of keyword A (step s130), the document link points (such as 1, 5) contained in the directory of keyword A are displayed. Moreover, a parent-son hierarchical relationship of the directory of keyword A and a plurality of second layer keyword directories contained in the directory of keyword A is also displayed. The second layer keyword directories {B, C, E, G, H} are united by the keywords of all documents contained in the corresponding upper layer first layer keyword A directory (there are 3 data displayed under the keyword A directory in the present embodiment) except for the keyword A of upper layer (step s140). That is, the names of the sub-keyword directories under the keyword A directory are composed of document 1, 5, 8 that are pointed by the document link points contained in the keyword A directory except for the keyword of keyword A. Many of multi-layer keyword directories can be generated dynamically via this kind of method.

When the user recognizes the document link point of the needed document by sight (step s150), the document link point of the needed document is selected (step s160). If there are too many document link points under the selected keyword directory, the needed document cannot be obtained. Thus, it is required to continuously select the lower layer keyword directory under the keyword directory (step s130). After repeatedly processing the operation of selecting the lower layer keyword directory, the user is able to select the needed document via the document link point displayed by some specific layer keyword directory.

The case mentioned above is when a lot of documents are stored in the database. However, when the data size is not too big, such as in a general personal account, there may be only several documents as shown in FIG. 2 of the present invention. Therefore, the document link point of the needed document is recognized when the user selects the first layer keyword directory, and under such a situation, the user also can select the document directly (step s170).

The disadvantage of the conventional file classification in the manual manner can be solved by classifying files by keyword. Since it is required for the conventional method to classify the file data continuously under the directory, the sub-directories are generated continuously, and as a result it is very difficult to know the exact location a file is located. However, if the file is classified by the keyword, since the keyword is extracted from the document content, the file can be easily found via the filtering operations layer by layer, as long as all the keywords selected by the user are the keywords of the data that is looking for.

Furthermore, in the intelligent document management, the add function and the delete function are included. The add function herein means after the user has finished the search steps and has referred to some document stored in the storage media 210 of the computer already, as exemplified by FIG. 2, it is assumed that the user finds the keyword D is also related to the document 1. The document link point corresponding to the selected document 1 is added into another keyword directory related to the document 1 by using the add function. That is, the document 1 is added to the keyword D directory. At this moment, the keyword string displayed from the attribute row 211 of the document 1 will comprise {A, B, C, D} rather than the {A, B, C} keyword contained in the previous attribute row. Moreover, one more record of data is displayed in the keyword D directory, that is, the document link points of 6 records of data are stored in the keyword D directory.

The delete function herein means after the user has finished the search steps and has referred to some document stored in the storage media 210 of the computer already, as exemplified by FIG. 2, it is assumed that the user finds the keyword A is not related tightly to the document 1. The document link point corresponding to the selected document 1 is deleted from the keyword A directory by using the delete function. At this moment, the keyword string displayed from the attribute row 211 of the document 1 will comprise {B, C, D} rather than the {A, B, C, D} keyword contained in the previous attribute row. Moreover, one less record of data is displayed in the keyword A directory, that is, the document link points of 2 records of data are stored in the keyword A directory.

Herein, the difference between the add function and creating file in the storage media 210 is further described. The add function is described above, and the operation of creating the file in the storage media 210 is also described already in the description mentioned above, step s100 to step 120 of FIG. 1, and therefore, it is not described here. However, no matter which level the keyword directory is in, the document link point contained in each keyword directory shown in the keyword directory table 200 is not displayed on the display screen in the numeric manner. For simplified description, the numeric herein only represents the file creating sequence of the document in the storage media 210.

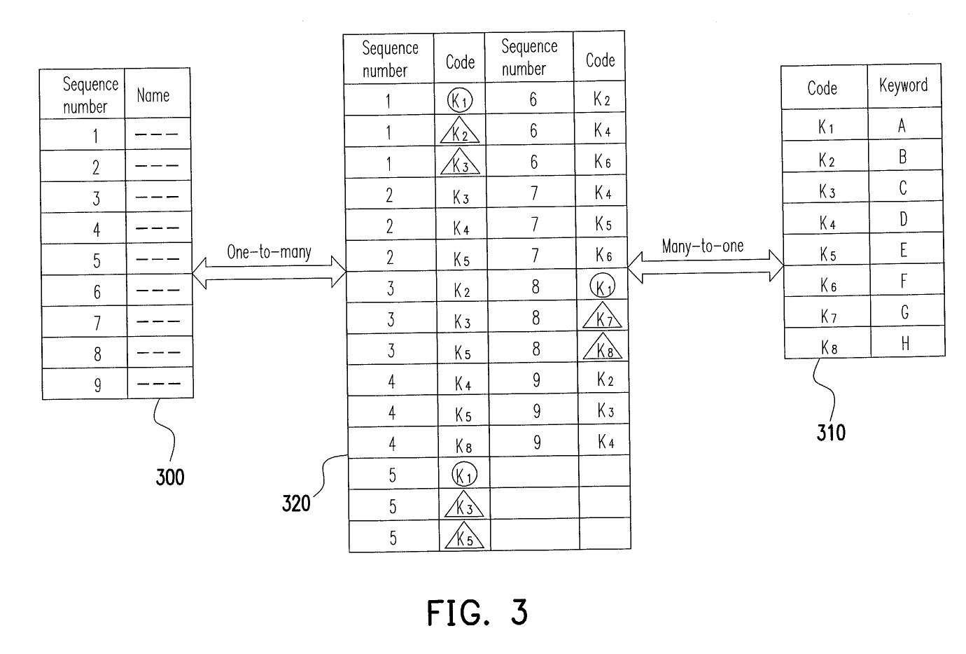

A physical method of a preferred embodiment for obtaining the first layer keyword directory, the second layer keyword directory . . . etc., that is mentioned above is described hereafter. Referring to FIG. 2 and FIG. 3: in the very beginning, providing a document list 300 that is related to all documents in the storage media 210, the 9 documents stored in the storage media 210 of the previous embodiment are utilized in the document list 300, wherein the document list 300 contains the sequence number and the naming (i.e. name) of these 9 documents. Moreover, there is a keyword list 310 that is obtained by using the extracted keywords, and the extracted keywords are represented by different codes in the keyword list 310, that is, the keywords {A, B, C, D, E, F, G, H} are sequentially represented by the k1˜k8 code.

Afterwards, a relationship index table 320 relating the documents and the keywords is obtained according to the document list 300 and the keyword list 310. The relationship index table 320 stores the sequence number related to the document and the code related to the keyword. That is, the keyword string contained in the attribute row of each document is listed. For example, the keyword extracted from the first document is {A, B, C}, and the corresponding code of the keyword {A, B, C} in the keyword list 310 is K1, K2, K3, therefore, the codes K1, K2, K3 corresponding to the document 1 are displayed in the relationship index table 320. The relationship index table 320 that is related to the other documents and keywords can also be obtained by analogy with this.

When a user selects the keyword A directory, the code K1 is obtained from the keyword list 310. The sequence numbers 1, 5, 8, corresponding to the code K1 respectively, are subsequently obtained from the relationship index table 320. The name of the document corresponding to the sequence number 1, 5, 8 is obtained after corresponding the sequence numbers obtained to the document list. Finally, the name of the document link point contained in the keyword A directory is displayed.

Moreover, FIG. 2, the keyword A directory also displays directories of other keywords that are united by the keywords extracted from the documents having the sequence number 1, 5, 8 excepting the keyword A, the directory of keyword B, C, E, G, H respectively in the present embodiment, and these keyword directories have a parent-son relationship with the upper layer keyword A directory, also displayed in the keyword directory table 200.

When the user repeatedly processes the operation of selecting the lower layer keyword directory, the steps mentioned above are repeated continuously, until the document link point displayed by some specific layer keyword directory is able to have the user easily recognize the document link point of the needed document. At this moment, the user can select the needed document; otherwise, the user can repeat the operation of selecting the keyword directory.

The method mentioned above is just an embodiment for dynamically generating the keyword directory according to the present invention. The present invention is not limited by it; different methods can also be used to obtain the keyword directory.

In summary, the advantage of the present invention is: the search path related to the file data can be dynamically generated when a file data is added, and the file data can be found via different search paths.

When the file data is added, the related directory is automatically generated or the file is added into the related directory automatically if the directory exists. Moreover, the directory shown in the screen is a hierarchical directory, and the directories that have been selected by the user are all displayed in the screen.

Although the invention has been described with reference to a particular embodiment thereof, it will be apparent to one of ordinary skill in the art that modifications to the described embodiment may be made without departing from the spirit of the invention. Accordingly, the scope of the invention will be defined by the attached claims not by the above detailed description.

What is claimed is:

1. An intelligent document management and usage method, wherein a storage media in the computer is used to store a plurality of documents, and there is a document link point corresponding to each of the documents, the intelligent document management and usage method comprises:
extracting automatically at least a keyword from each of the documents respectively, and using it as a plurality of attribute rows corresponding to the documents;
providing a keyword directory table on the display screen for user usage and management, wherein the keyword directory table comprises a plurality of first keyword directories, the first keyword directories are composed of the union of the keywords contained in the documents;
wherein, when the user selects one of the first keyword directories, the document link points contained in the first keyword directory are displayed, moreover, a parent-son hierarchical relationship of the first keyword directory and a plurality of second keyword directories contained in the first keyword directory is also displayed, wherein the second keyword directories are united by the keywords of all the documents contained in the first keyword directory corresponding to the upper layer except for the keyword of the upper layer; and
wherein, when the user repeatedly processes the operation of selecting the lower layer keyword directory, as long as the specific keyword directory displays the document link point of the document needed by the user, the user can select the needed document.

2. The method of claim 1, further comprising an add step and a delete step.

3. The method of claim 2, wherein the add step comprises:
the user adding the document link point corresponding to the selected document to another keyword directory related to the document; and
adding at least a keyword to the attribute row corresponding to the document.

4. The method of claim 2, wherein the delete step comprises:
the user deleting the document link point corresponding to the selected document from the keyword directory; and
deleting at least a keyword from the attribute row corresponding to the document.

5. An intelligent document management and usage method, wherein, a storage media stores a plurality of documents, and there is a document link point corresponding to each of the documents, the intelligent document management and usage method comprises:
providing a document list related to the documents;
extracting automatically at least a keyword from each of the documents, and using it as a plurality of attribute rows corresponding to the documents;
obtaining a keyword list by using the keywords;
obtaining a relationship index table according to the document list and the keyword list;
providing a keyword directory table to the display screen for user usage and management, wherein the keyword directory table comprises a plurality of first keyword directories, and the first keyword directories are obtained according to the relationship index table;
wherein, when the user selects one of the first keyword directories, the document link points contained in the first keyword directory are displayed, moreover, a parent-son hierarchical relationship of the first keyword directory and a plurality of second keyword directories contained in the first keyword directory is also displayed, wherein according to the relationship index table, the second keyword directories are united by the keywords of all the documents contained in the first keyword directory corresponding to the upper layer except for the keyword of the upper layer; and
wherein, when the user repeatedly processes the operation of selecting the lower layer keyword directory, as long as the specific keyword directory displays the document link point of the document needed by the user, the user can select the needed document.

6. The method of claim 5, further comprising an add step and a delete step.

7. The method of claim 6, wherein the add step comprises:
the user adding the document link point corresponding to the selected document to another keyword directory related to the document; and
adding at least a keyword to the attribute row corresponding to the document.

8. The method of claim 6, wherein the delete step comprises:
the user deleting the document link point corresponding to the selected document from the keyword directory; and
deleting at least a keyword from the attribute row corresponding to the document.

9. The method of claim 5, wherein the relationship between the document list and the keyword list is many-to-many.

10. The method of claim 5, wherein the relationship between the document list and the keyword list is one-to-many.

11. The method of claim 5, wherein the relationship between the document list and the keyword list is many-to-one.
